(19) United States
(12) Patent Application Publication
(10) Pub. No.: US 2023/0049310 A1
(43) Pub. Date: Feb. 16, 2023

(54) OPTICAL CONNECTING DEVICE, OPTICAL DEVICE, AND MANUFACTURING METHOD FOR OPTICAL DEVICE

(71) Applicant: Nippon Telegraph and Telephone Corporation, Tokyo (JP)

(72) Inventors: Yohei Saito, Tokyo (JP); Kota Shikama, Tokyo (JP); Norio Sato, Tokyo (JP)

(21) Appl. No.: 17/796,811

(22) PCT Filed: Feb. 10, 2020
(86) PCT No.: PCT/JP2020/005084

§ 371 Date: Aug. 1, 2022

(51) Int. Cl. G02B 6/122; G02B 6/13

(52) U.S. Cl. CPC G02B 6/122; G02B 6/13

(57) ABSTRACT

An embodiment is an optical connection element including a first waveguide core and a second waveguide core on a substrate, the first waveguide core and the second waveguide core configured to propagate a signal light and a resin-curing light, and a mode field conversion portion provided at one end of the first waveguide core, wherein the second waveguide core covers at least the mode field conversion portion on the substrate, and a refractive index of the first waveguide core is higher than a refractive index of the second waveguide core.

### CROSS-REFERENCE TO RELATED APPLICATIONS

This application is a national phase entry of PCT Application No. PCT/JP2020/005084, filed on Feb. 10, 2020, which application is hereby incorporated herein by reference.

### TECHNICAL FIELD

The present invention relates to an optical connection element for connecting optical elements, an optical element using the optical connection element, and a method for manufacturing an optical element.

### BACKGROUND

With the development of optical communication networks, higher functionality and space saving of optical communication devices are required, and in order to meet these demands, high-density integration and miniaturization of devices are progressing. In the integration of optical communication devices, it is important to connect different types of optical devices such as semiconductor lasers, optical switches, and optical fibers with low-loss.

In connecting optical devices, precise positioning between the optical devices is important. For that reason, for example, even in optical connectors and the like used for general purposes, high-precision components are used in which an optical axis deviation between waveguides is limited to 1 μm or less, and for manufacturing optical communication devices, designs and precision components in which strict tolerances are considered are indispensable.

As a technique that can relax positioning accuracy between optical devices required for the optical connection, there is a self-written waveguide (hereinafter referred to as “SWW”) technique. This technique is an optical connection technique that uses a material whose refractive index is irreversibly increased by light and can provide connection between waveguides through roughly three steps.

First, a photocurable resin is dropped between the waveguides. In this case, light used as signal light for optical communication is emitted from at least one waveguide core end face. Also, in this case, a gap is assumed to already exist between the waveguides.

Next, resin-curing light that is light for curing the photocurable resin is radiated from each waveguide. In this case, due to the nature of being sequentially cured from a place at which light intensity is high, which is a characteristic of the photocurable resin, cores are sequentially formed from respective waveguide end faces. Thus, SWW core portions are always formed on end faces of the cores.

Further, due to the same nature, even if there is an optical axis deviation between the waveguides, the SWW core portions caused by bending are formed to compensate for the deviation, and thus even if there is the axis deviation or a gap, waveguides bent in S shapes are formed to compensate for it, and a low-loss optical connection can be realized.

Finally, after uncured portions of the photocurable resin have been washed away, the optical connection via SWW is completed by dropping a cladding resin on those portions.

In principle, the present technique is a connection technique that has an axis deviation compensation effect which can realize a low-loss connection even if there is a gap or optical axis deviation between waveguides, which is a factor of connection loss between waveguides, and thus the positioning accuracy required for mounting the optical device can be relaxed. For that reason, it is possible to relax a tolerance requirement for components constituting the optical devices, and thus there is a possibility that simple optical integration and reduction in costs of members can be realized.

In relation to the present technique, conventionally, formation into an optical device of a quartz-based core is most common, and formation into an optical fiber, an optical plane circuit, or the like configured of the core has been reported. On the other hand, there is no report about formation from an end face of a semiconductor-based optical circuit used as a light source of an optical communication device. A semiconductor-based optical circuit is a device having an optical waveguide including a semiconductor material serving as a core and is excellent in integration due to a high refractive index that the semiconductor material has. Especially among the above, silicon photonics, in which Si serves as a core, has been attracting attention in recent years due to its compatibility with a CMOS process of its manufacturing process.

However, in those devices, positioning accuracy and strict tolerances at the time of connection beyond conventional quartz-based core optical devices are required, and there is a problem that a process load of optical connection increases. This is because, generally in optical connection, a tolerance requirement at the time of optical connection becomes stricter as a mode filed diameter of light (hereinafter referred to as “MFD”) is smaller, and thus a more accurate positioning technique is required for optical connection of a semiconductor-based optical circuit device having a minute MFD. As a solution thereto, application of an SWW, which can relax its positioning accuracy as described above, to semiconductor-based optical circuit is expected.

### CITATION LIST

### Non Patent Literature

[NPL 1] Naohiro Hirose et al., “Optical Component Coupling Using Self-Written Waveguides”, Journal of The Japan Institute of Electronics Packaging, Vol.₅, No.₅, (2002)

### SUMMARY

### Technical Problem

However, it is currently difficult to apply SWW to the connection of a semiconductor-based optical circuit. The reason is that, in a semiconductor-based optical circuit, it is difficult to emit resin-curing light from a waveguide end face from which signal light used in optical communication required for forming an SWW core portion is emitted.

This results from the fact that, in a semiconductor-based optical circuit, signal light propagates within a core of a semiconductor material, while since the semiconductor material has strong absorption for light in a visible band, which is a wavelength band in which resin-curing light is mainly present, the resin-curing light cannot propagate to a sufficient distance in the core of the semiconductor-based optical circuit due to a strong absorption loss.

The embodiments of present invention has been made to solve the above problems and enables optical elements made of various materials including semiconductors to achieve a high-precision and low-loss optical connection.

### Means for Solving the Problem

In order to solve the above-mentioned problems, an optical connection element according to embodiments of present the present invention is an optical connection element including: a first waveguide core and a second waveguide core, to which signal light and resin-curing light propagate, on a substrate or a cladding; and a mode field conversion portion provided at one end of the first waveguide core, wherein the second waveguide core is formed to cover at least the mode field conversion portion on the substrate or the cladding, and a refractive index of the first waveguide core is higher than a refractive index of the second waveguide core.

Also, an optical connection element according to embodiments of present the present invention is an optical connection element including: a first waveguide core and a second waveguide core, to which signal light and resin-curing light propagate, on a substrate or a cladding; and a mode field conversion portion provided at one end of the first waveguide core, wherein the second waveguide core is formed to cover the mode field conversion portion on the substrate or the cladding, a refractive index of the first waveguide core is higher than a refractive index of the second waveguide core, and a part of the second waveguide core that covers a portion of the first waveguide core other than the mode field conversion portion is provided with an optical coupling portion that couples the resin-curing light, and a light introduction waveguide that propagates the resin-curing light to be introduced into the second waveguide core 111 the optical coupling portion.

Also, a method for manufacturing an optical element according to embodiments of present the present invention is a method for manufacturing an optical element including: an optical connection element that includes a first waveguide core and a second waveguide core, to which signal light and resin-curing light propagate, on a substrate or a lower cladding portion, a refractive index of the first waveguide core being higher than a refractive index of the second waveguide core; and a self-written waveguide connected to an end face of the second waveguide core, the method including: forming the first waveguide core on the substrate or the lower cladding portion; forming the second waveguide core to cover at least the mode field conversion portion of the first waveguide core; forming an upper cladding portion on the second waveguide core; disposing a material of the self-written waveguide on the end face of the second waveguide core; propagating the resin-curing light to the second waveguide core; and irradiating the material of the self-written waveguide with the resin-curing light to increase a refractive index of the material of the self-written waveguide, thereby forming a core of the self-written waveguide.

### Effects of the Invention

According to embodiments of present the present invention, it is possible to realize a high-precision and low-loss optical connection to optical elements made of various materials.

### BRIEF DESCRIPTION OF THE DRAWINGS

FIG. 1 is a top perspective view of an optical element in which an SWW is connected to an optical connection element according to a first embodiment of the present invention.

FIG. 2 is a top perspective view of the optical connection element according to the first embodiment of the present invention.

FIG. 3 is a cross-sectional view along line III-III′ of the optical connection element according to the first embodiment of the present invention.

FIG. 4 is a cross-sectional view along line IV-IV′ of the optical connection element according to the first embodiment of the present invention.

FIG. 5 is a cross-sectional view of a waveguide structure used for calculating an electric field amplitude of a propagation mode in the optical connection element according to the first embodiment of the present invention.

FIG. 6 is a diagram showing a calculation result of an electric field amplitude in a propagation mode in an optical connection element according to the first embodiment of the present invention.

FIG. 7 is a diagram showing an example of a method for making resin-curing light incident on the optical connection element according to the first embodiment of the present invention.

FIG. 8 is a top perspective view of an optical connection element according to a second embodiment of the present invention.

FIG. 9 is a top perspective view of an optical connection element according to Modified example 1 of the second embodiment of the present invention.

FIG. 10 is a top perspective view of an optical connection element according to Modified example 2 of the second embodiment of the present invention.

FIG. 11 is a cross-sectional view along line XI-XI′ in the optical connection element according to Modified example 2 of the second embodiment of the present invention.

FIG. 12 is a top perspective view of an optical connection element according to Modified example 3 of the second embodiment of the present invention.

FIG. 13 is a top perspective view of an optical connection element according to Modified example 4 of the second embodiment of the present invention.

FIG. 14 is a top perspective view of an optical connection element according to Modified example 5 of the second embodiment of the present invention.

FIG. 15 is a top perspective view of an optical connection element according to a third embodiment of the present invention.

FIG. 16 is a cross-sectional view along line XVI-XVI′ in the optical connection element according to the third embodiment of the present invention.

FIG. 17 is a cross-sectional view showing an example of using a diffraction grating in the optical connection element according to the third embodiment of the present invention.

FIG. 18 is an enlarged view of a diffraction grating portion in an optical connection element according to a modified example of the third embodiment of the present invention.

FIG. 19 is a top perspective view of the optical connection element according to the modified example of the third embodiment of the present invention.

FIG. 20 is a top perspective view of an optical connection element according to a fourth embodiment of the present invention.

FIG. 21 is a top perspective view of the vicinity of an intersection portion in the optical connection element according to the fourth embodiment of the present invention.

FIG. 22 is a cross-sectional view along line XXII-XXII′ in an optical connection element according to a modified example of the fourth embodiment of the present invention.

FIG. 23 is a top perspective view of the optical connection element according to the modified example of the fourth embodiment of the present invention.

### DETAILED DESCRIPTION OF ILLUSTRATIVE EMBODIMENTS

### First Embodiment

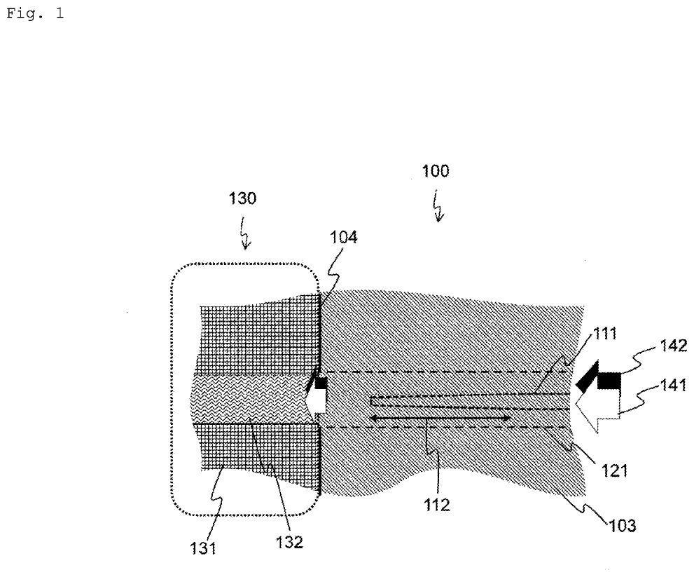

An optical connection element according to a first embodiment of the present invention will be described with reference to FIGS. 1 to 4.

Configuration of optical connection element

FIG. 1 shows a top perspective view of an optical element in which a third waveguide portion 130 is connected to an optical connection element 100 according to the first embodiment of the present invention. The optical connection element 100 includes a first waveguide core 111, a second waveguide core 121 that covers the first waveguide core 111, and an upper cladding portion 103 on the second waveguide core 121. A tip surface of the first waveguide core 111 is disposed inside the second waveguide core 121, and a mode field conversion portion 112 is provided at a tip of the first waveguide core 111. The third waveguide portion 130 is connected to an emission end 104 of the optical connection element 100, and more specifically to an end face of the second waveguide core 121. Hereinafter, with respect to the second waveguide core 121, an upper cladding portion 103 side is defined as “upward”, and a lower cladding portion 102 (which will be described later) side is defined as “downward”.

Here, the third waveguide portion 130 is an SWW and includes a cladding portion 131 and a core 132. In the present embodiment, a photocurable resin is used for an SWW material.

Further, in the first waveguide core 111, a width of a portion other than the mode field conversion portion 112 is 400 nm. A length of the mode field conversion portion 112 is 300 !LIM, and a width thereof varies from 400 nm at a proximal end to 8o nm at a distal end thereof. A width of the second waveguide core 121 is 3 μm. A distance from a tip of the mode field conversion portion 112 to the emission end 104 is about 100 μm.

The present embodiment has a circuit structure, in which the second waveguide core 121 is present to cover the first waveguide core 111 provided with the mode field conversion portion 112, to enable formation of the core 132 of the third waveguide portion made of an SWW.

In the present embodiment, signal light 141 and resin-curing light 142 can be incident on the first waveguide core 111 and the second waveguide core 121 at an incidence end (not shown) of the optical connection element 100. The signal light 141 mainly propagates through the first waveguide core 111, seeps into the second waveguide core 121 in the mode field conversion portion 112, and propagates through the second waveguide core 121 to be emitted from the emission end 104.

On the other hand, the resin-curing light 142 is used at the time of forming SWW, which is the third waveguide portion 130, and mainly propagates through the second waveguide core 121 and is emitted from the emission end 104. When the resin-curing light 142 is emitted from the emission end 104, specifically, the material of the third waveguide portion 130 disposed on the end face of the second waveguide core 121, a refractive index of the irradiated portion increases to form the core 132 of the third waveguide portion. Details will be described below.

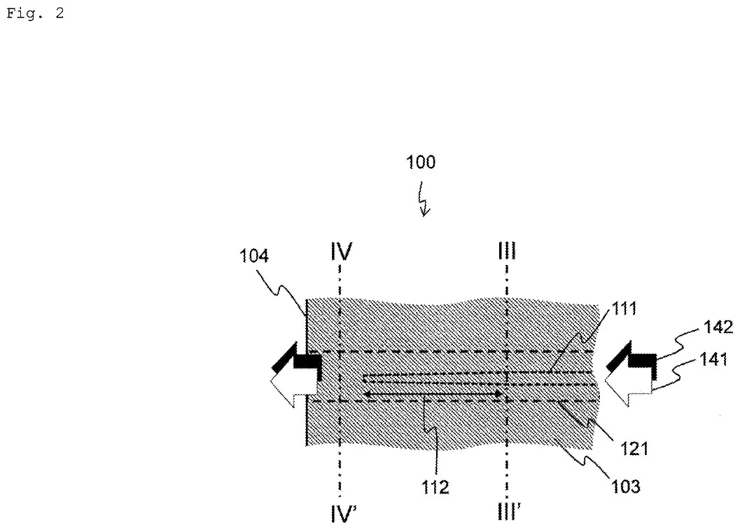

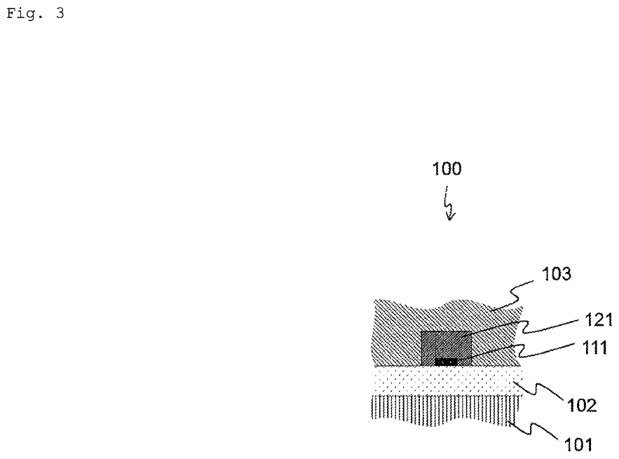

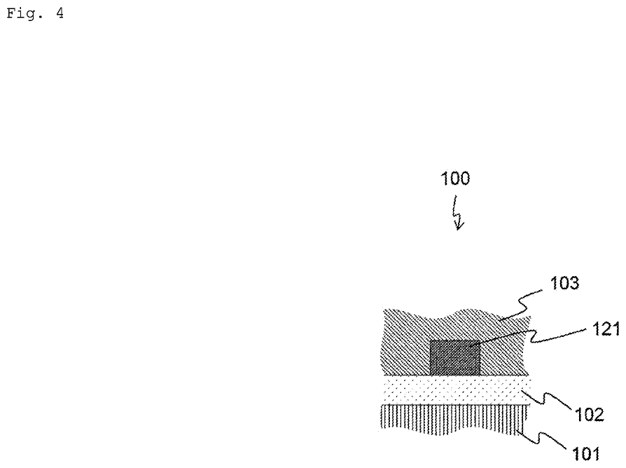

FIG. 2 shows a top perspective view of the optical connection element 100 including the first waveguide core 111 and the second waveguide core 121. FIGS. 3 and 4 are cross-sectional views along lines III-III′ and IV-IV′ in FIG. 2, respectively. Along line III-III′ inside the optical connection element 100, the lower cladding portion 102, the first waveguide core 111, the second waveguide core 121 that covers the first waveguide core 111, and the upper cladding portion 103 are provided on the substrate 101. Along line IV-IV′ in the vicinity of the emission end of the optical connection element 100, the first waveguide core 111 is not present, and the lower cladding portion 102, the second waveguide core 121, and the upper cladding portion 103 are provided on the substrate 101.

Here, a thickness of the lower cladding portion 102 is 5 um, a thickness of the first waveguide core 111 is 20 nm, a thickness of the second waveguide core 121 is 3 μm, and a thickness of the upper cladding portion 103 is 5 μm.

Also, as shown in FIG. 3, the first waveguide core 111 is disposed substantially at a center of a bottom surface (a surface in contact with the lower cladding portion 102) of the second waveguide core 121 in a cross-section facing a light guiding direction, but even when not disposed substantially at the center, it may be disposed so that the signal light 141 that has seeped from the first waveguide core 111 can propagate in the second waveguide core 121 in a single mode.

Also, for the upper cladding portion 103 and the lower cladding portion 102 in the present structure, for example, a silicon oxide (SiO2 or SiOx) is used, but any other material that has a lower refractive index than the second waveguide core 121 and serves as a cladding portion can also be adopted.

Also, the lower cladding portion 102 is not always necessary, and for example, in a case in which the substrate 101 is silicon oxide, the first waveguide core 111 made of Si may be formed directly on the substrate 101.

Also, Si can be used for the substrate 101, and other materials such as sapphire and glass can also be used.

Actually, as materials constituting the present structure, for example, Si is used for the first waveguide core 111, and SiON produced by adding nitrogen to silicon oxide is used for the second waveguide core 121. Further, in addition to semiconductors such as InP and GaAs, dielectrics, resins, or the like can also be considered for the first waveguide core 111, and in addition to dielectrics such as SiOx, resin materials, semiconductors, or the like can be considered for the second waveguide core 121. As described above, there are many possible combinations of materials, but the present structure does not limit the materials as long as the first waveguide core 111 has a higher refractive index than the second waveguide core 121 and the second waveguide core 121 has a higher refractive index than the upper cladding portion 103. Hereinafter, in the embodiments of the present invention, Si will be used for the first waveguide core 111 and SiON will be used for the second waveguide core 121 as an example.

First, the propagation of the signal light 141 will be described.

A waveguide structure including the first waveguide core 111 and the second waveguide core 121 in the present embodiment is a structure generally used for adiabatic transition of light to cores having different cross-sectional areas (for example, Japanese Patent No. 3543121). The present waveguide structure has waveguide cores having different MFDs of the first waveguide core 111 and the second waveguide core 121, so that it can connect the first waveguide core 111 to the second waveguide core 121 with low-loss with the mode field conversion portion 112 of the first waveguide core 111.

In the present structure, light confined in the first waveguide core 111 goes through a process in which confinement of the light becomes weaker as a width of the core gradually narrows toward a tip of a tapered portion thereof, and the MFD is gradually increased toward the inside of the second waveguide core 121. After that, the light transitions to a light mode propagating in the second waveguide core 121 and propagates inside it. Thus, the signal light 141 that has transitioned to the second waveguide core 121 is emitted from the emission end 104.

Further, in addition to the simple tapered structure in which the width of the waveguide core tapers as it approaches the end of the first waveguide core 111 as shown in FIG. 1, the mode field conversion portion 112 may have any of various structures such as a structure in which the thickness of the waveguide core decreases as it approaches the end of the first waveguide core 111, and a structure in which the mode field conversion portion 112 is divided into three branches, but the present invention does not limit the shape. After going through the process in which the light confined in the first waveguide core 111 becomes weaker toward the tip, and the MFD is gradually increased toward the second waveguide core 121, the light may preferably transition to the light mode propagating in the second waveguide core 121 and can propagate inside it.

Further, this structure enables propagation of the resin-curing light 142 of the waveguide, which is indispensable for emission from the waveguide end face, which is necessary for realizing the formation of the SWW core. The propagation of the resin-curing light 142 performed by the present structure will be described below.

In the present structure, if the second waveguide core 121 is sufficiently transparent to the resin-curing light 142, that is, if an extinction coefficient that a material relating to light absorption has is sufficiently low, the resin-curing light 142 can propagate in a region of the second waveguide core 121 around the first waveguide core 111 including the mode field conversion portion 112.

As a material constituting the second waveguide core 121 and transparent to the resin-curing light 142, for example, SiON produced by adding nitrogen to silicon oxide is used. Other materials may be semiconductors, dielectrics, resins, or the like as long as they are transparent to the resin-curing light 142 and have a lower refractive index than the first waveguide core 111, but the present invention is not limited thereto.

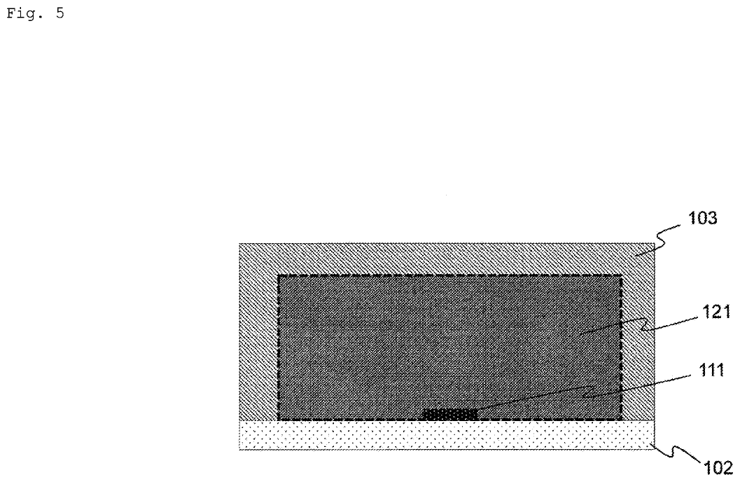

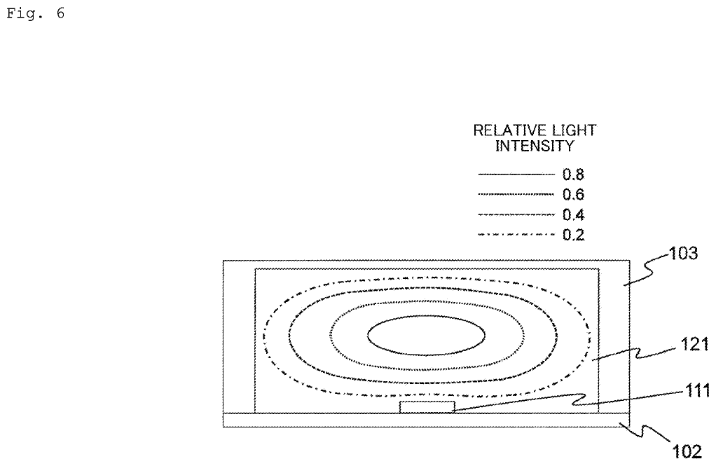

FIG. 5 shows a structure used in the calculation assuming that the second waveguide core 121 is SiON, the lower cladding portion 102 and the upper cladding portion 103 are silicon oxide, and the first waveguide core 111 is Si. This structure corresponds to the cross-section (FIG. 3) along line III-III′ in FIG. 2. FIG. 6 shows results of numerically calculating a normalized electric field amplitude of a propagation mode of the present structure. Here, software “MODE Solutions” (produced by Lumerical) was used for the calculation. Further, the electric field amplitude is standardized by the maximum value of the electric field amplitude in the present structure and is shown as a relative light intensity.

The resin-curing light 142 is distributed in the region of the second waveguide core 121 above the first waveguide core 111 with a relative light intensity of 0.2 or more. In this way, in the present structure, it is possible to confine the resin-curing light 142 and propagate the resin-curing light 142 to the region of the second waveguide core 121 which is transparent to the resin-curing light 142.

With the present structure, the resin-curing light 142 propagating through a part of the second waveguide core 121 passes around the mode field conversion portion 112 of the first waveguide core 111, propagates to the waveguide of only the second waveguide core 121, and is emitted from the emission end 104 of the optical connection element 100. As described above, the signal light 141 propagating through the first waveguide core 111 also finally propagates through the second waveguide core 121. With the above, it is possible to realize the emission of the resin-curing light 142 necessary for forming the SWW core from the waveguide end face from which the signal light 141 is emitted.

Further, the resin-curing light 142 is incident on the first waveguide core 111 and the second waveguide core 121 at the incidence end (not shown). Here, as compared with a propagation loss when the resin-curing light 142 propagates in the first waveguide core 111 made of a semiconductor material, a propagation loss of the resin-curing light 142 in the second waveguide core 121 of the present structure is remarkably small, but it is difficult to completely avoid an influence of absorption of the semiconductor material. As a result, for example, when compared with a normal waveguide configured of only the second waveguide core 121 and a cladding portion, the propagation loss of the resin-curing light 142 in the present structure is large.

However, the light intensity per unit area of the resin-curing light 142 required to realize SWW is low, and for example, about several tens of μW is sufficient for a thickness of 3 μm and a width of 3 μm of the second waveguide core 121. In addition, an output of a commercially available and relatively inexpensive semiconductor laser in a wavelength band of the resin-curing light 142 is about several mW, and thus even if there is some loss, it is possible to secure a sufficient output for forming SWW.

The configuration of the optical element in which SWW is actually formed by the present structure is as shown in FIG. 1 described above. That is, it is configured of the first waveguide core 111, the second waveguide core 121 covering the first waveguide core 111, and the third waveguide portion 130 having the core 132 formed by the resin-curing light 142 propagating these structures thereof. By the present structure emitting the resin-curing light 142 from the emission end 104, the core 132 of the third waveguide portion 130 formed by SWW can be formed.

As described above, according to the optical connection element according to the present embodiment, in a case in which a wavelength of the resin-curing light 142 is shorter than a wavelength of the signal light 141, the signal light 141 can seep out from the first waveguide core 111 to the second waveguide core 121 in the mode field conversion portion near the output end and propagate, and the resin-curing light can propagate through the second waveguide core 121. As a result, the signal light 141 can propagate when a device is operating, and the resin-curing light 142 can propagate when SWW is formed.

Therefore, a low-loss optical connection can be realized for an optical element including waveguides made of various materials including semiconductor-based waveguides, and positioning accuracy at the time of mounting an optical device can be relaxed. As a result, a high-precision and simple optical connection and integration of optical devices can be realized at low cost.

Method for manufacturing optical element using optical connection element

In a method for manufacturing the optical element that optically connects the third waveguide portion 130 to the optical connection element 100 of the present embodiment, as described above, the process of optical connection using SWW mainly consists of three steps of dropping a resin, forming SWW by emitting the resin-curing light 142, and forming the cladding portions.

As an example of the method for manufacturing the present element, in detail, first, the optical connection element 100 of the present embodiment is manufactured. First, a material of the lower cladding portion 102, for example, silicon oxide, and a material of the first waveguide core 111, for example, Si are laminated on the substrate 101.

Next, Si is processed into the first waveguide core 111 using ordinary photolithography. Next, a material of the second waveguide core 121, for example, SiON, is laminated on the first waveguide core 111 to cover the first waveguide core 111.

Next, SiON is processed into the second waveguide core 121 using ordinary photolithography.

Finally, the upper cladding portion 103 is formed on the second waveguide core 121 to cover the second waveguide core 121 by using, for example, silicon oxide for a material thereof.

Next, the optical element is manufactured in the process of optical connection performed by SWW. First, a material for the third waveguide portion 13o, for example, a photocurable resin, is dropped (disposed) on the end face of the second waveguide core 121 of the above-mentioned optical connection element 100.

Next, the resin-curing light 142 propagates to the second waveguide core 121.

Next, the photocurable resin is irradiated with the resin-curing light 142 and photocured to form the core 132 of the third waveguide portion.

Next, in the photocurable resin, the portion of the photocurable resin that has not been irradiated with the resin-curing light 142 and has not been cured is washed and the like and removed.

Finally, a resin is dropped (disposed) around the photocured photocurable resin to form the cladding portion 131 of the third waveguide portion.

Here, a solid SWW material can also be used as the material of the core 132 of the third waveguide portion. In this case, first, the SWW material is fixed to the end face of the second waveguide core 121 with an adhesive or the like, and then irradiated with the resin-curing light 142. As a result, the irradiated portion becomes the core 132 of the third waveguide portion, and the unirradiated portion becomes the cladding portion 131. In this case, it is not necessary to remove the portion that has not been photocured and to drop (dispose) the resin on the cladding portion.

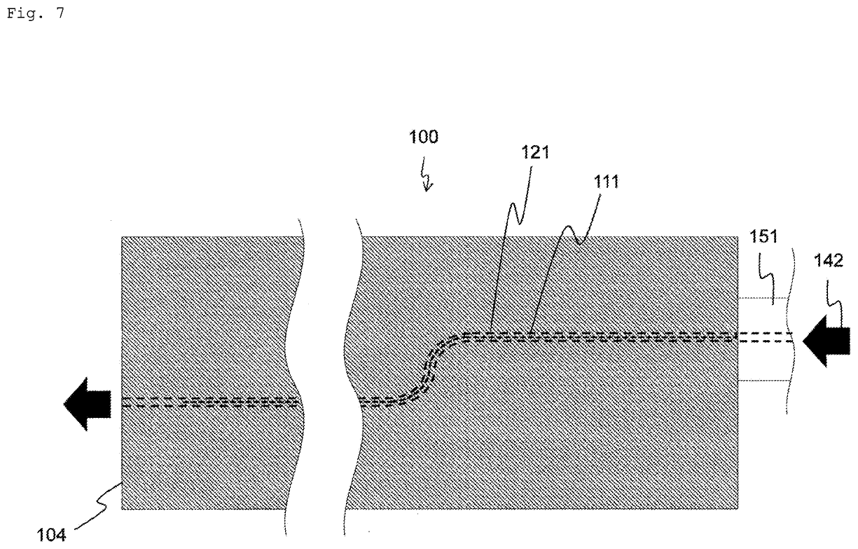

As shown in FIG. 7, for a method for making the resin-curing light 142 incident on a waveguide at this time, there is a method of producing the waveguide including the first waveguide core 111 and the second waveguide core 121 up to an end different from the emission end, and abutting an optical fiber 151 thereon to make the resin-curing light 142 incident on the waveguide. Here, the dotted line in the optical fiber 151 in FIG. 7 indicates an optical fiber core, and the resin-curing light 142 mainly propagates through the optical fiber core 111 the optical fiber 151.

In addition, the incident portion of the resin-curing light 142 is disposed at the opposite end portion of the optical connection element 100 when viewed from the emission end 104 in FIG. 7, but the present invention does not limit the location of the incident portion of the resin-curing light 142. Also, as for the method for making the resin-curing light 142 incident, it is not always necessary to use the optical fiber 151 as shown in FIG. 7, and for example, a method performed by a spatial optical system using a lens or the like may be used.

With respect to the resin-curing light 142 in the present embodiment, for example, 405 nm can be used for the wavelength at which the SWW core portion, which is the core 132 of the third waveguide portion, can be formed. Light of other wavelengths can be used to form the SWW core portion, and depending on the SWW material, light having a wavelength of 550 nm or less including 480 nm and light having a wavelength of 400 nm or less including 385 nm can be used. In this way, it is possible to form SWW in the optical connection element 100 by using various kinds of SWW materials and wavelengths of the resin-curing light, and the present invention does not limit the type of SWW material and the wavelength of the resin-curing light.

Also, the material that can achieve SWW may be solid or liquid. For example, the waveguide can be formed with a solid resin or a crystalline material having a nature of a refractive index being increased due to photoreaction.

As described above, according to the method for manufacturing the optical element using the optical connection element 100 of the present embodiment, the optical element including waveguides made of various materials including semiconductor-based waveguides can be manufactured with a low-loss optical connection using SWW and relaxed positioning accuracy at the time of mounting optical devices. As a result, it is possible to manufacture an optical element in which optical devices are integrated with high precision and simple optical connection at low cost.

### Second Embodiment

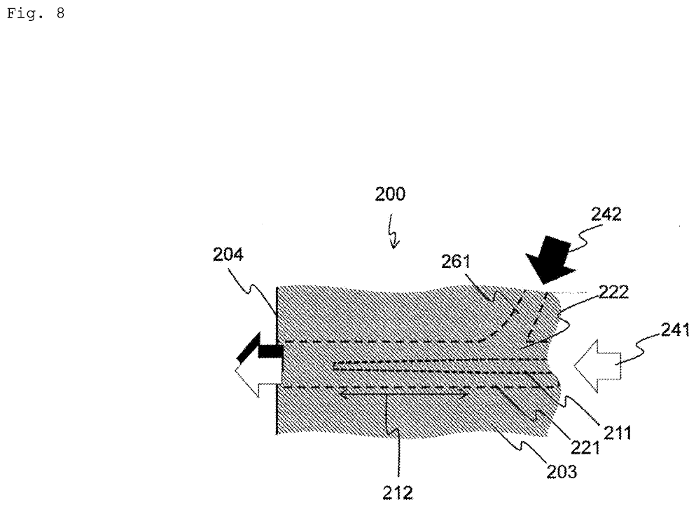

A second embodiment of the present invention will be described with reference to FIG. 8. The present embodiment has substantially the same configuration and effects as the first embodiment, but differs therefrom in the following points.

In the case of the first embodiment, there remains problems when the resin-curing light is incident on an optical device from the outside and in a range of devices that can be formed. A problem of the first embodiment is that the signal light and the resin-curing light propagate in almost the same region, and thus in a case in which the first waveguide core and the second waveguide core are discontinuous, the resin-curing light cannot be emitted from the end face that emits the signal light.

In addition, in a structure in which a semiconductor laser, an optical receiver, and the like are coupled to an optical waveguide and integrated on a substrate, even in a case in which only the signal light can be incident on the optical waveguide from the incidence end (not shown) and the resin-curing light cannot be incident, the resin-curing light cannot be emitted from the end face that emits the signal light.

Further, as described above, the structure configured of the second waveguide core covering the first waveguide core has an increased propagation loss as compared to a normal waveguide consisting of one core and one cladding portion. For that reason, in the case of a large-scale circuit configuration, the structure has also a problem of an increased propagation distance that makes resin-curing light difficult to be emitted from an end face of a waveguide to which the resin-curing light is to be connected.

In order to solve these problems, the second embodiment includes an optical coupling portion 222 that couples resin-curing light 242 to a part of a second waveguide core 221 that covers a portion other than a mode field conversion portion 212 of a first waveguide core 211, and a waveguide (hereinafter referred to as a “light introduction waveguide”) 261 that introduces the resin-curing light 242 into the second waveguide core 221.

The optical coupling portion 222 can be realized by a substantially Y-shaped optical coupling portion 222 formed in the second waveguide core 221 as shown in FIG. 8, for example. The optical coupling portion 222 can spatially separate transmission lines of the resin-curing light 242 and signal light 241 from their respective circuit structures. As a result, a degree of freedom of an optical waveguide structure for the resin-curing light 242 suitable for optical connection via SWW is increased, and thus it is possible to further simplify the coupling of the resin-curing light 242 to a semiconductor-based optical circuit and to increase the number of devices to which the optical connection via SWW can be applied.

Further, as described above, the present structure is formed in a part of the second waveguide core 221 that covers a portion other than the mode field conversion portion 212, which makes it possible to combine the resin-curing light 242 while inhibiting an influence of a mode field conversion function that increases MFD of the signal light 241.

Specifically, in the portion other than the mode field conversion portion 212 described above, the signal light 241 is sufficiently confined in a minute semiconductor core. Further, a size of the structure of the present embodiment is such that a width of the first waveguide core 211 is about 400 nm and a width of the second waveguide core 221 is about 3 μm, and the Y-shaped optical coupling portion 222 formed in the second waveguide core 221 is physically separated from a region in which the signal light 241 is confined (first waveguide core 211) by 1 μm or more. As a result, the light confined to the first waveguide core 211 is optically unaffected by the structure of the optical coupling portion 222.

This makes it possible to realize that the signal light 241 and the resin-curing light 242 are coupled to the same waveguide without affecting the signal light 241, which is important for the optical coupling portion 222.

Further, in the mode field conversion portion 212, light gradually seeps from a portion of the first waveguide core 211 to a portion of the second waveguide core 221. For this reason, in a case in which the optical coupling portion 222 is produced in this portion, the light is easily affected by the structure of the optical coupling portion 222, which may affect the loss and the mode field conversion. Thus, in order to avoid this influence, it is preferable to form the optical coupling portion 222 in a part of the second waveguide core 221 that covers the portion other than the mode field conversion portion 212.

In the present structure, the transmission lines of the signal light 241 and the resin-curing light 242 can be separated as described above. Accordingly, in order to couple the resin-curing light 242 having a higher intensity, as shown in FIG. 8, it is desirable that the light introduction waveguide 261 of the Y-shaped optical coupling portion 222 through which the light propagates have the same structure as the waveguide having the second waveguide core 221 and an upper cladding portion 203. As the structure, for example, a waveguide in which SiON is used for a core and silicon oxide is used for a cladding portion can be considered.

Further, in the case of the configuration shown in FIG. 8, an excessive loss for the resin-curing light 242 occurs at the time of coupling in the Y-shaped portion. However, as described above, since the power of the resin-curing light 242 required for producing SWW may be weak, the effect of this excessive loss on the formation of SWW is small.

Modified example of second embodiment

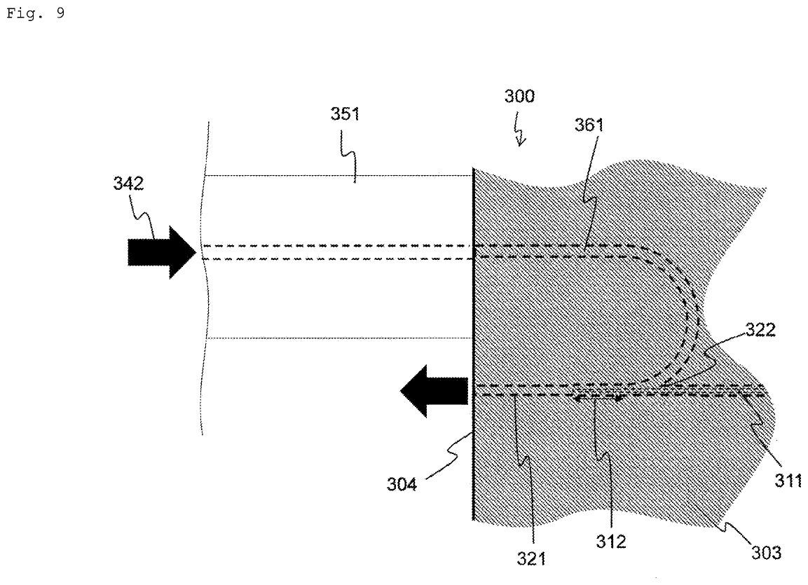

Hereinafter, a modified example of the second embodiment will be described with reference to FIGs. 9 to 14.

By producing the structure for making the resin-curing light incident from the outside of the optical connection element at the end of the light introduction waveguide in the optical connection element according to the second embodiment, the light can be incident in various directions such as in a horizontal direction of the optical connection element or from an upper side of the optical connection element. This also makes it possible to form SWW in the above-mentioned structure in which a semiconductor laser and an optical receiver are integrated.

Modified Example 1

For example, as the method for making the resin-curing light incident in the horizontal direction of the optical connection element, a method for making light incident by butt-coupling an optical fiber (FIG. 9) will be described.

In an optical connection element 300 according to the present modified example, an end face on which resin-curing light 342 is incident and an end face from which the resin-curing light 342 is emitted are the same end face (emission end) 304. An optical fiber 351 is brought into contact with the emission end 304, and the resin-curing light 342 is incident thereon from the outside through the optical fiber 351. The resin-curing light 342 propagates through a light introduction waveguide 361 and is coupled to a waveguide structure including a first waveguide core 311 and a second waveguide core 321 in an optical coupling portion 322. Finally, the light propagates through the second waveguide core 321 and is emitted from the emission end 304. The emitted resin-curing light 342 is applied to an SWW material to form SWW (not shown). In addition, a method for making light incident using a lens is also conceivable.

Modified Example 2

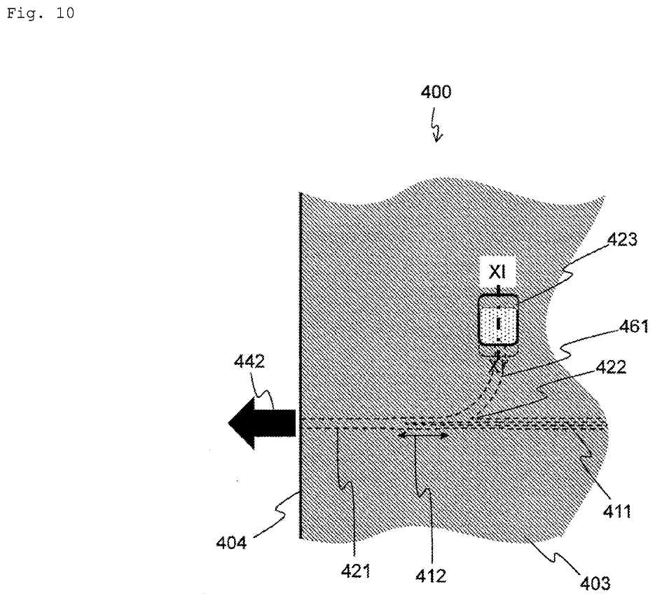

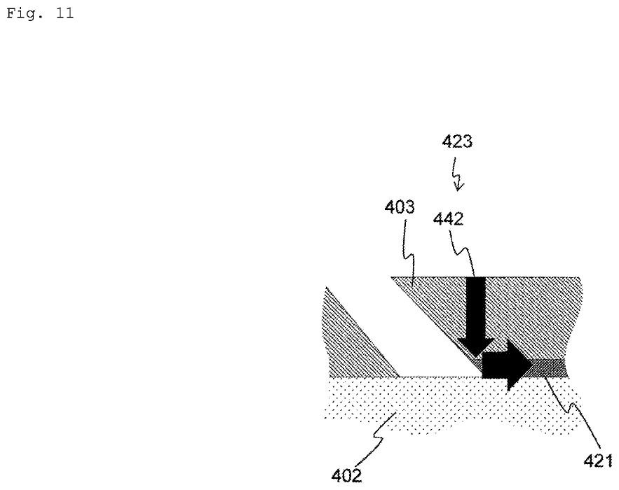

For example, as a method for making the resin-curing light incident from above the optical connection element, a method of using a mirror 423 produced in an optical device by machining will be described. FIG. 10 is a top perspective view of an optical connection element 400 according to the present modified example, and FIG. 11 is a cross-sectional view along line XI-XI′ shown in FIG. 10. Here, the mirror 423 can be formed by injecting an etching gas in an oblique direction from above a device to perform dry etching. Further, for the purpose of increasing a reflectance of the mirror and eliminating polarization dependence, a metal film may be formed on the mirror formed by performing deposition or the like of a metal such as aluminum on an etching portion to perform etching.

In the optical connection element 400 according to the present modified example, the resin-curing light 442 is incident from above the optical connection element 400 and reflected by the mirror 423 formed at an end of a light introduction waveguide 461. The reflected resin-curing light 442 propagates through the light introduction waveguide 461 and is coupled to a waveguide structure including a first waveguide core 411 and a second waveguide core 421 in an optical coupling portion 422. Finally, the light propagates through the second waveguide core 421 and is emitted from the emission end 404. The emitted resin-curing light 442 is applied to an SWW material to form SWW (not shown). In addition, a method of using a grating coupler or the like can be considered.

As described above, in the optical connection element 400 according to the present modified example, the resin-curing light 442 is incident from above the optical connection element 400. The mirror 423 is used as a mechanism for propagating the resin-curing light 442 incident on the second waveguide core 421 through the light introduction waveguide 461. As a result, the resin-curing light 442 can be emitted from the emission end 404.

With any of these incident methods, the formation of SWW can be realized by the structure of the present invention as long as the light can be sufficiently combined.

Modified Example 3

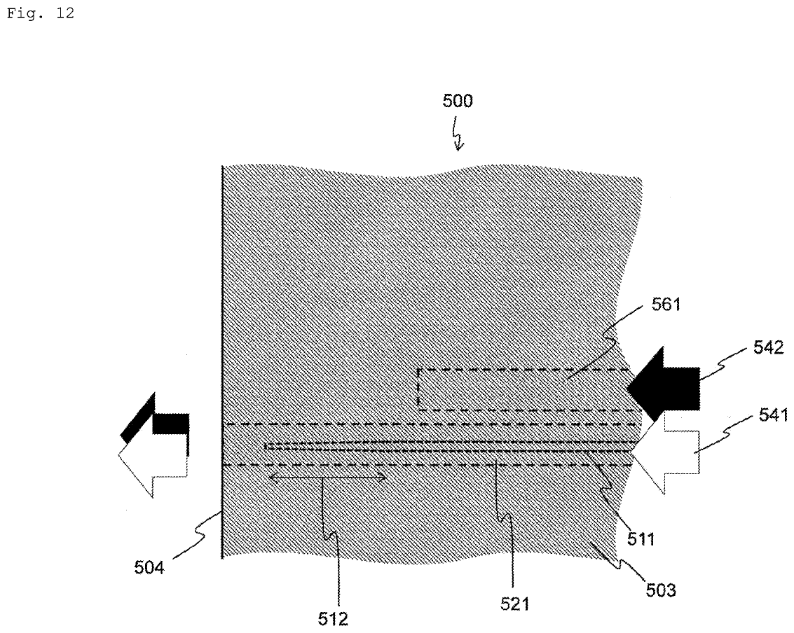

As the optical coupling portion in the optical connection element according to the second embodiment, in addition to the Y-shape, a mode coupling using a parallel waveguide such as a directional coupler can be considered (FIG. 12).

In an optical connection element 500 according to the present modified example, resin-curing light 542 is incident on a light introduction waveguide (parallel waveguide) 561 and propagates to be mode-coupled to a waveguide structure including a first waveguide core 511 and a second waveguide core 521. Finally, the light propagates through the second waveguide core 521 and is emitted from an emission end 504 thereof. The emitted resin-curing light 542 is applied to an SWW material to form SWW (not shown).

Further, signal light 541 mainly propagates through the first waveguide core 511, seeps into the second waveguide core 521 in a mode field conversion portion 512, propagates through the second waveguide core 521, and is emitted from the emission end 504.

Modified Example 4

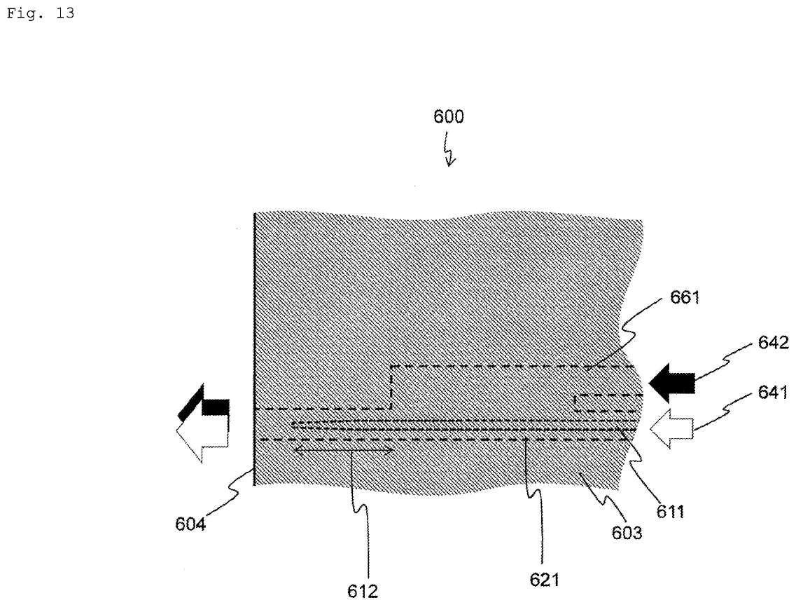

As the optical coupling portion in the optical connection element according to the second embodiment, one using interference generated by a waveguide structure such as a multimode interference waveguide can be considered (FIG. 13).

In an optical connection element 600 according to the present modified example, resin-curing light 642 is incident on a light introduction waveguide (multimode interference waveguide) 661 and coupled to a waveguide structure including a first waveguide core 611 and a second waveguide core 621. Finally, the light propagates through the second waveguide core 621 and is emitted from the emission end 604. The emitted resin-curing light 642 is applied to an SWW material to form SWW (not shown).

Further, signal light 641 mainly propagates through the first waveguide core 611, seeps into the second waveguide core 621 in a mode field conversion portion 612, propagates through the second waveguide core 621, and is emitted from the emission end 604.

In the modified examples 3 and 4, in order to emit the signal lights 541 and 641 and the resin-curing lights 542 and 642 from the same emission ends 504 and 604, these waveguide structures require a structure including the first waveguide cores 511 and 611 and the second waveguide cores 521 and 621 as in the present invention, instead of a normal structure consisting of one core and one cladding portion. For that reason, due to the influence of absorption of semiconductor cores of the first waveguide cores 511 and 611 on the resin-curing lights 542 and 642, an excessive loss at the time of coupling the resin-curing lights 542 and 642 increases as compared with a directional coupler having a normal waveguide structure consisting of one core and one cladding portion. However, as described above, since some loss of the resin-curing lights 542 and 642 is allowed, there is no influence on the formation of SWW.

Modified Example 5

A modified example of the example (modified example 3) of using the mode coupling performed by the parallel waveguide serving as the optical coupling portion in the optical connection element according to the second embodiment will be described.

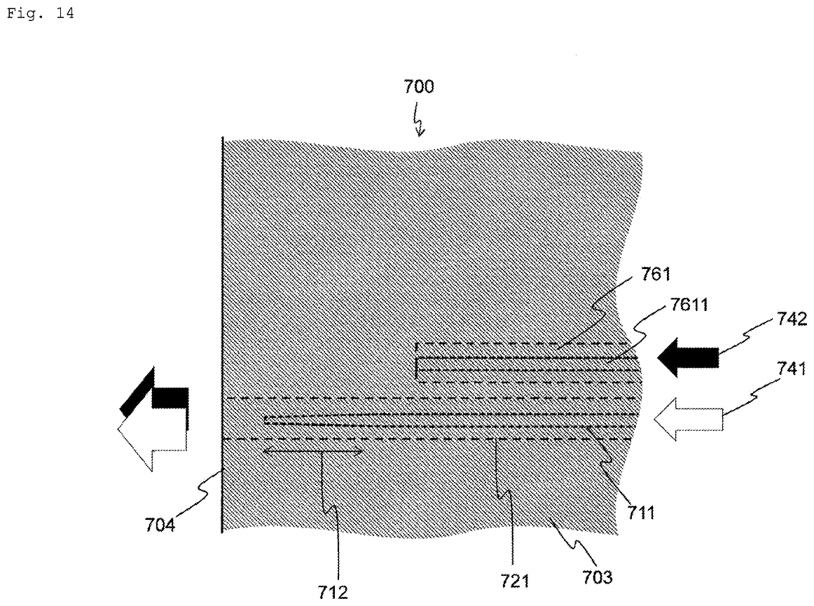

In the case of an optical coupling portion using mode coupling performed by adjacent parallel waveguides, as shown in the structure of FIG. 14, the coupling efficiency from a light introduction waveguide 761 to a waveguide including a first waveguide core 711 and a second waveguide core 721 is maximized when propagation constants between modes of each waveguide are equal, and thus structures of each waveguide may be the same so that the propagation constants are the same. That is, unlike FIG. 12, the light introduction waveguide 761 may have a structure having a waveguide core 7611 corresponding to the first waveguide core 711, as shown in FIG. 14.

However, in this case, since the light introduction waveguide 761 also needs to have a structure equivalent to that of the waveguide including the first waveguide core 711 and the second waveguide core 721, there is a concern that a propagation loss of resin-curing light 742 will increase. In this case, while the coupling efficiency of the optical coupling portion is increased, it is conceivable that a propagation loss of optical power to reach that location will increase.

Accordingly, in the case of the structure shown in FIG. 14, the power coupling efficiency of the resin-curing light 742 incident from the outside of the optical connection element 700 does not necessarily increase as compared with the case shown in FIG. 12. It is conceivable that a combination that achieves maximum efficiency for a balance between the propagation loss and the coupling efficiency varies depending on a material of an optical element and a design of a core cross-section to which the present structure is applied, and thus it may be appropriately designed according to an optical element to which the present structure is applied so that the desired coupling efficiency can be realized.

### Third Embodiment

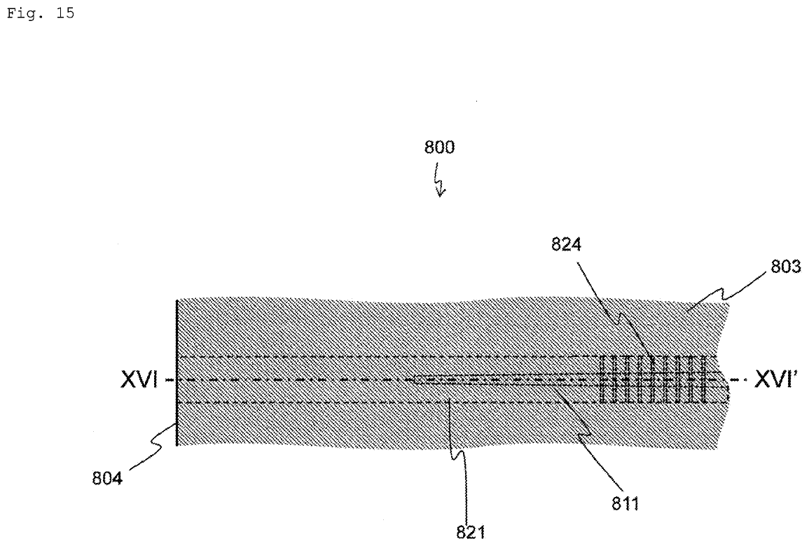

A third embodiment of the present invention will be described with reference to FIGS. 15 to 19. The present embodiment has substantially the same configuration and effects as the first and second embodiments, but differs therefrom in the following points.

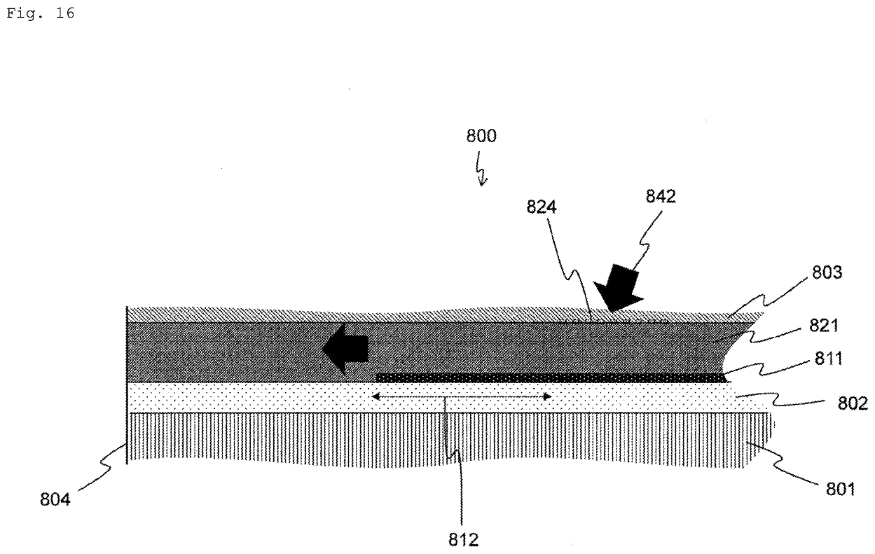

FIG. 15 is a top perspective view of an optical connection element 800 according to the third embodiment, and FIG. 16 is a cross-sectional view along line XVI-XVI′ in FIG. 15. The third embodiment has a form in which light can be incident from above the optical connection element 800 without having a waveguide for transmitting resin-curing light (a light introduction waveguide) as in the second embodiment.

Specifically, a grating coupler 824 is formed above a first waveguide core 811 and on a part of an upper surface of a second waveguide core 821 having a constant width, which enables direct light incidence of resin-curing light 842 and coupling to a waveguide at the same time. Here, a metal material such as Au or Al is used for the grating coupler 824.

In the optical connection element 800, after the resin-curing light 842 is incident on the grating coupler 824, it is diffracted and coupled to the second waveguide core 821, propagates through the second waveguide core 821, and is emitted from an emission end 804 thereof. The emitted resin-curing light 842 is applied to an SWW material to form SWW (not shown). An advantage of the present embodiment is that it does not require a space for transmitting resin-curing light in the optical connection element as compared with the second embodiment.

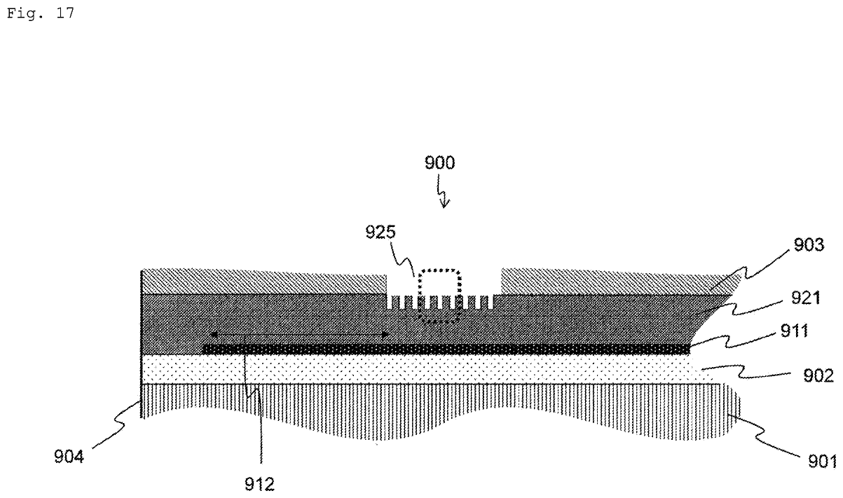

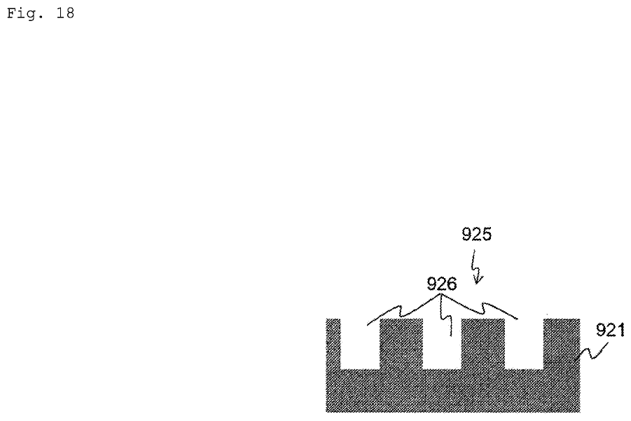

For the grating coupler, in addition to those using metal materials such as Au and Al, a diffraction grating 925 (FIGS. 17 and 18) configured of an interface between air 926 and a second waveguide core 921, which is formed by machining, may be used as long as it is a grating coupler capable of coupling resin-curing light.

As described above, in the optical connection element according to the present embodiment, the grating coupler 824 or the diffraction grating 925 is used for a mechanism for making the resin-curing light incident from above the optical connection element and propagating it to the second waveguide core 421, so that the resin-curing light can be emitted from the emission end.

Modified Example of Third Embodiment

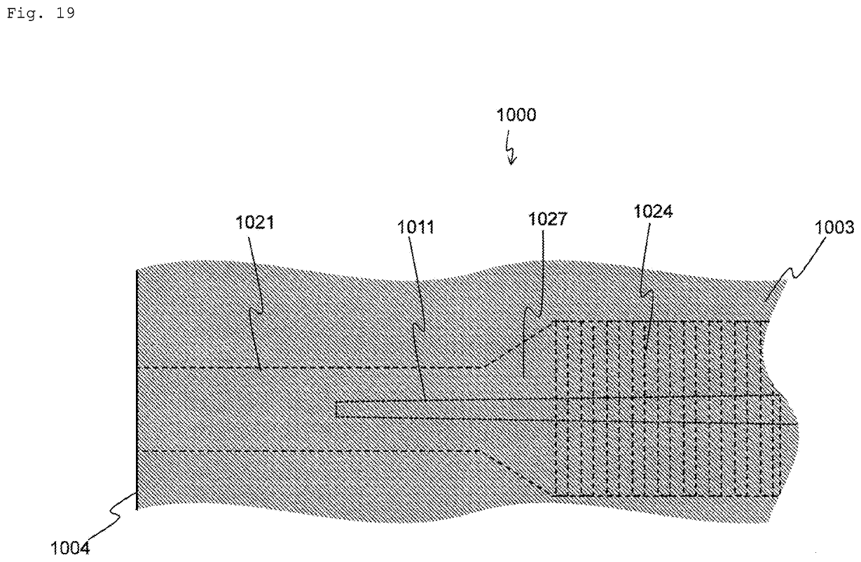

A modified example of the third embodiment will be described below with reference to FIG. 19.

In an optical connection element 1000 according to the present modified example, as shown in FIG. 19, a width of a grating coupler 1024 can be increased by disposing a tapered portion 1027 to increase a width of a second waveguide core 1021. As a result, since this leads to enlargement of MFD of light at an incident portion on an upper surface of an optical device, the positioning accuracy at the time of optical coupling from the outside of the optical device can be relaxed.

### Fourth Embodiment

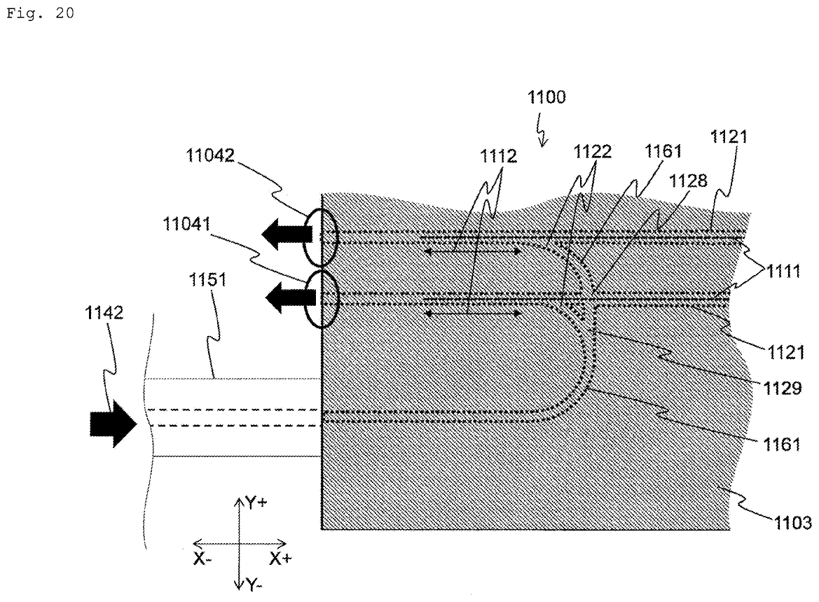

A fourth embodiment of the present invention will be described with reference to FIGS. 20 to 22. The present embodiment has substantially the same configuration and effects as the first to third embodiments, but differs therefrom in the following points.

In the fourth embodiment, even though there is only one input location for resin-curing light, optical power is branched by using a circuit structure, which makes it possible to simultaneously emit the resin-curing light from emission ends of a plurality of semiconductor-based optical circuits and to form SWWs in their respective waveguides at the same time.

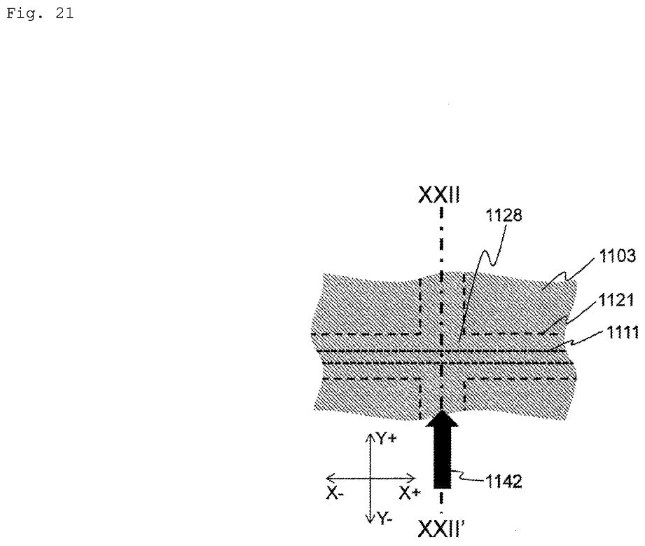

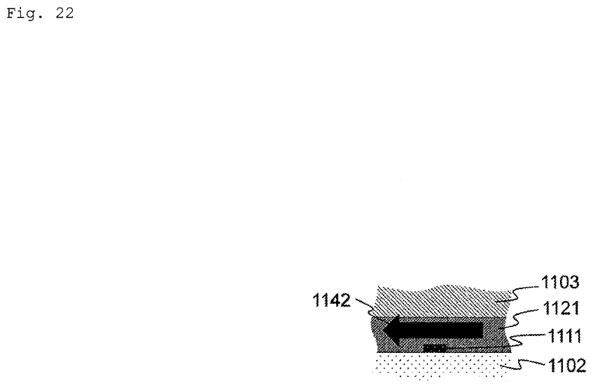

Next, the details of an optical connection element 1100 according to the present embodiment will be described. FIG. 20 shows a top perspective view of the optical connection element 1100 according to the fourth embodiment, and FIG. 21 shows a top perspective view of the vicinity of an intersection portion of the optical connection element 1100 according to the fourth embodiment. In the figure, X+, X−, Y+, and Y− directions are shown as propagation directions of resin-curing light 1142. Also, FIG. 22 shows a cross-sectional view along line XXII-XXII′ shown in FIG. 21.

First, the resin-curing light 1142 input from an optical fiber 1151 is branched by a branch structure 1129. One of the branched lights is coupled to a second waveguide core 1121 by an optical coupling portion 1122 having a Y-shaped structure, propagates in the X− direction (shown in FIG. 20), and is emitted from a first emission end 11041.

The other light passes through the branch structure 1129 and then propagates in the waveguide in the Y+ direction (shown in FIG. 20) and reaches an intersection portion 1128 at which the second waveguide core 1121 intersects crosswise.

As shown in FIGS. 21 and 22, the intersection portion 1128 has a structure in which, in addition to the intersection portion 1128, there is a first waveguide core 1111 serving as a step below the second waveguide core 1121 to which the resin-curing light 1142 propagating in the Y+direction (shown in FIG. 21) propagates. For that reason, the resin-curing light 1142 is diffracted or reflected by the stepped structure of the first waveguide core 1111, and thus a loss is generated. However, as described above, the light required for forming the SWW core may be weak, and thus no significant influence is generated even though there is some loss.

After passing through this intersection portion 1128, the resin-curing light 1142 propagates through a light introduction waveguide 1161 in the Y+direction (shown in FIG. 20), and similarly to the first emission end 11041, the light is coupled to the second waveguide core 1121 by the optical coupling portion 1122, propagates in the X− direction (shown in FIG. 20), and is emitted from a second emission end 11042.

As described above, since the resin-curing light 1142 can be emitted from the two emission ends 11041 and 11042 at the same time, it is possible to connect two waveguide connection portions at the same time using SWW.

Also, in the present embodiment, only the emission from two waveguide end faces is performed, but by combining the branched structure and the intersection structure, it is possible to simultaneously emit the resin-curing light from two or more waveguide end faces. This also makes it possible to connect an even larger number of waveguides at the same time.

Modified Example of Fourth Embodiment

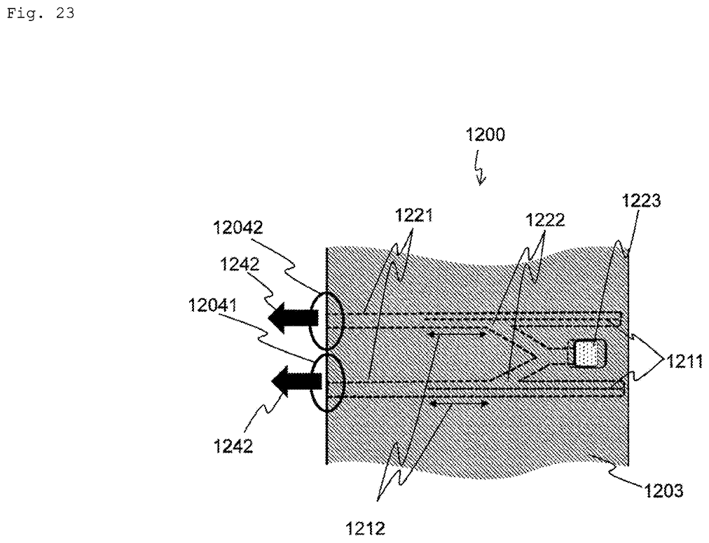

A modified example of the fourth embodiment will be described below with reference to FIG. 23.

The above-mentioned mirror 1223 is formed at the incident portion using an optical connection element 1200 as shown in FIG. 23, and thus it is possible to form SWWs at the same time on two waveguides without requiring the intersection portion. However, in a case in which the resin-curing light is emitted from a more complicated circuit configuration or two or more waveguides at the same time, it is difficult to use only the configuration as shown in FIG. 23, and it is conceivable that the intersection portion is required.

Further, besides the method of coupling from the end face of the optical element via the optical fiber as shown in FIG. 20, light may be incident from above the optical connection element by a mirror, a grating coupler, or the like. Also in this case, by branching the light using the branch structure or the intersection structure of the light, the batch connection as in the present embodiment becomes possible.

The embodiments of the present invention may have a structure in which the second waveguide core covers at least the mode field conversion portion of the first waveguide core. In this case, the structure may be such that the signal light seeps out to the second waveguide core via the mode field conversion portion of the first waveguide core and propagates, and the resin-curing light is incident to the second waveguide core and propagates.

In the embodiment of the present invention, the waveguide structure including two waveguide cores, i.e., the first waveguide core and the second waveguide core, is used, but the number of waveguide cores is not limited to two, and a plurality of waveguide cores having different refractive indexes may be used. In this case, the structure may be such that the signal light and the resin-curing light can be guided and emitted from an end face (emission end) of an element forming SWW.

In the embodiments of the present invention, a mirror, a grating coupler, a diffraction grating, or the like can be used as the mechanism that not only makes the resin-curing light incident from the end face of the optical connection element using the optical fiber or the optical waveguide and propagates it to the second waveguide core, but also makes the resin-curing light incident from above the optical connection element and propagates it to the second waveguide core.

In the embodiments of the present invention, a liquid photocurable resin was used as the SWW material, but the present invention is not limited thereto, and any material whose refractive index increases due to light irradiation may be used.

The dimensions of the optical connection elements, the optical elements using the optical connection elements, and the constituent portions, components, and the like of the methods for manufacturing the optical elements according to the first to fourth embodiments of the present invention have been described, but the present invention does not limit the dimensions, and any dimension may be used as long as each constituent portion, component, or the like functions.

In particular, in the waveguide structure such as the first waveguide core, the second waveguide core, or the like, the propagation may be performed such that the signal light can propagate in a single mode, and the resin-curing light can be output with a light intensity sufficient to form SWW.

The optical connection elements and the optical elements using the optical connection elements according to the second to fourth embodiments of the present invention can be manufactured using substantially the same method as the manufacturing method shown in the first embodiment.

### INDUSTRIAL APPLICABILITY

The embodiments of present the present invention relate to an optical connection element for connecting an optical element, an optical element using the optical connection element, and a method for manufacturing the optical element, and can be applied to devices and systems such as optical communication.

Reference Signs List

| | |
|---|---|
| 100 | Optical connection element |
| 101 | Substrate |
| 102 | Lower cladding portion |
| 103 | Upper cladding portion |
| 104 | Emission end |
| 111 | First waveguide core |
| 112 | Mode field conversion portion |
| 121 | Second waveguide core |
| 130 | Third waveguide portion (self-written waveguide) |
| 141 | Signal light |
| 142 | Resin-curing light |

1-8. (canceled)

9. An optical connection element comprising:
a first waveguide core and a second waveguide core on a substrate, the first waveguide core and the second waveguide core configured to propagate a signal light and a resin-curing light; and
a mode field conversion portion provided at one end of the first waveguide core, wherein
the second waveguide core covers at least the mode field conversion portion on the substrate, and
a refractive index of the first waveguide core is higher than a refractive index of the second waveguide core.

10. The optical connection element according to claim 9, further comprising:
a cladding, the cladding being between the substrate and the first waveguide core and the second waveguide, wherein the second waveguide core covers at least the mode field conversion portion on cladding.

11. The optical connection element of claim 9, wherein a part of the second waveguide core that covers a portion of the first waveguide core other than the mode field conversion portion is provided with an optical coupling portion configured to couple the resin-curing light, and a light introduction waveguide configured to propagate the resin-curing light to be introduced into the second waveguide core in the optical coupling portion.

12. The optical connection element according to claim 9, further comprising:
an emission end configured to emit the signal light and the resin-curing light.

13. The optical connection element according to claim 9 configured to connect a self-written waveguide to an emission end, the emission end configured to emit the signal light and the resin-curing light, wherein
a refractive index of the self-written waveguide is increased by the resin-curing light emitted from the emission end.

14. The optical connection element according to claim 13, wherein
the self-written waveguide is made of a photocurable resin.

15. The optical connection element according to claim 9, further comprising:
a mirror configured to make the resin-curing light incident from above the optical connection element and propagate the resin-curing light to the second waveguide core.

16. The optical connection element according to claim 9, further comprising:
a self-written waveguide connected to an end face of the second waveguide core.

17. A method for manufacturing an optical element including, the method comprising:
forming a first waveguide core on a substrate;
forming a second waveguide core to cover at least a mode field conversion portion of the first waveguide core, a refractive index of the first waveguide core being higher than a refractive index of the second waveguide core;
forming an upper cladding portion on the second waveguide core;
disposing a material of a self-written waveguide on an end face of the second waveguide core;
propagating a resin-curing light to the second waveguide core; and
irradiating the material of the self-written waveguide with the resin-curing light to increase a refractive index of the material of the self-written waveguide to form a core of the self-written waveguide.

18. The method according to claim 17, wherein the core of the self-written waveguide being connected to the end face of the second waveguide core.

19. The method according to claim 17, further comprising:
a lower cladding portion on the substrate, the first waveguide core being on the lower cladding portion.

20. The method of claim 17, further comprising:
propagating a signal light to the first waveguide core.

21. The method of claim 17, wherein
the self-written waveguide is made of a photocurable resin.

22. The method of claim 17, wherein
the resin-curing light is incident from above the optical element.
